(19) United States
(12) Patent Application Publication
(10) Pub. No.: US 2020/0078744 A1
(43) Pub. Date: Mar. 12, 2020

(54) METHOD OF PRODUCING A HOLLOW FIBER MEMBRANE

(71) Applicant: Aquaporin A/S, Kgs. Lyngby (DK)

(72) Inventors: Krzysztof TRZASKUS, Kgs. Lyngby (DK); Mariana SPULBER, Charlottenlund (DK); Jörg VOGEL, København S (DK)

(21) Appl. No.: 16/493,981

(22) PCT Filed: Mar. 15, 2018
(86) PCT No.: PCT/EP2018/056561

§ 371 Date: Sep. 13, 2019

(30) Foreign Application Priority Data
Mar. 16, 2017 (DK) PA201770186

(51) Int. Cl. B01D 69/12; B01D 69/08; B01D 71/60; B01D 71/68; B01D 63/02; B01D 61/00; B01D 69/02; C02F 1/44; F03G 7/04

(52) U.S. Cl. CPC B01D 69/125; B01D 69/08; B01D 71/60; B01D 71/68; B01D 63/02; B01D 61/002; C02F 2103/026; C02F 1/445; F03G 7/04; B01D 2323/40; B01D 2325/34; C02F 1/441; C02F 1/442; B01D 69/02

(57) ABSTRACT

A method of producing a hollow fiber membrane having an outside coating with a thin film composite (TFC) layer with a transmembrane protein, the method including the steps of: preparing an aqueous solution including a self-assembled nanostructure including polyalkyleneimine (PAI) and a detergent solubilized transmembrane protein and a di- or triamine, preparing an apolar solution including a di- or triacyl halide in an apolar organic solvent, contacting a hollow fiber membrane with the either the solution according to step a) or the solution according to step b), removing excess solution if any, contacting the hollow fiber membrane with the other solution, allowing an interfacial polymerization reaction to take place, and rinsing the hollow fiber membrane with an aqueous solvent. The hollow fiber is applicable e.g. for extracting water from the product solution.

### FIELD

The aspects of the disclosed embodiments relate to a method of producing a hollow fiber membrane having an outside coating with a thin film layer comprising self-assembled nanostructures formed between transmembrane proteins, such as aquaporin water channels (AQPs), and polyalkyleneimines (PAI), and to filtration membranes comprising the nanostructures. The present invention further relates to single fibers as well as hollow fiber modules including such nanostructures.

### BACKGROUND

The use of amphiphilic lipids and block copolymers for forming self-assembled vesicles having bilayer or bilayer-like structures is well known in the art, in particular for immobilising amphiphilic membrane proteins, such as aquaporin water channels (AQPs). Vesicles comprising AQPs can then be used to make membranes having immobilised AQPs for applications such as the purification of water (WO2006/122566) or the generation of salinity power (WO2007/033675), in general by depositing the vesicles as a layer or in a film on a supporting substrate, which allows the selective passage of water molecules through the membranes by nanofiltration, reverse osmosis, forward osmosis or pressure retarded osmosis.

WO2013/043118 discloses thin film composite (TFC) membranes in which aquaporin water channels (AQPs) are incorporated in the active layer of the membrane. In addition, it discloses a method of producing thin film composite membranes and their uses in filtration processes, such as nanofiltration and osmotic filtration processes. The TFC membranes comprise lipid-AQP/copolymer-AQP vesicles that are incorporated in the TFC active layer. WO2010/146365 describes preparation of TFC-aquaporin-Z (AqpZ) filtration membranes that use an amphiphile triblock copolymer as a vesicle forming substance for incorporating immobilised AQPs. WO2014/108827 discloses a hollow fiber (HF) module having fibers modified with a thin film composite (TFC) layer comprising aquaporin water channels in which the aquaporin water channels are incorporated in vesicles before incorporation into the TFC layer.

However, typically in the prior art, the amphiphilic lipids and block copolymers used in vesicle production are solids that need to be dissolved in harsh solvents, such as tetrachloromethane (CCl₄) or chloroform (CHCl₃), to solubilise their predominantly hydrophobic portions. In the membrane synthesis, this solvent is evaporated to allow film formation which is then rehydrated to bring the amphiphile into various emulsion forms (such as vesicles), with simultaneous incorporation of the AQP membrane protein. However, in practice, it is often difficult to control the final vesicle size, resulting in disperse emulsions having vesicles ranging in diameter of from about 60 to 80 nm to about 1000 nm or more. There may also be limits to the number of AQPs that can be incorporated in each vesicle, because the membrane proteins need to be aligned according to their amphiphilic structure in the bilayer structure and to match the thickness of the hydrophobic part of the protein and vesicle membrane.

Polyethylenimine (PEI) is known as a versatile vector for gene transfer into cells because it has a high cationic density that enables it to form complexes with negatively charged DNA. In this application, the PEI-DNA complexes provide a stable environment for the DNA against enzymatic degradation, for example providing a physical barrier to the enzymes or by the electrostatic interactions between the PEI and the enzyme (Thomas & Venkiteswaran, Biophysical Journal, 106(2): 276-277, 2014). PEI exist both in linear, branched and dendritic forms. The linear chains have secondary amine groups while the branched chains or dendrimers may have primary, secondary and tertiary amine groups. It is also known from the literature that short polyethyleneimine (PEI, Mw 600) has been selected as a cationic backbone to which lipid tails conjugate at various levels of saturation. In solution these polymer-lipid hybrids self-assemble to form nanoparticles capable of complexing siRNA. The complexes silence genes specifically and with low cytotoxicity (Schroeder A, et al., J. of Controlled Release, 160(2): 172-176, 2012).

### SUMMARY

The aspects of the disclosed embodiments relate to a Error! Reference source not found.

The present inventors have realized that polyalkyleneimines (PAI), such as polyethyleneimine (PEI), forms self-assembled nanostructures with transmembrane proteins, or integral membrane proteins (pore proteins), such as aquaporin water channels. The PAI-protein nanostructures may then be used in the production of separation membranes in which the transmembrane proteins are immobilized and active, for example for allowing water molecules to pass through the membrane. For example, for the production of separation membranes comprising the transmembrane proteins, the self-assembled nanostructures may be suspended in an aqueous liquid composition that can be included in an interfacial polymerization reaction on a semipermeable support to form a thin film composite active membrane layer, or the self-assembled nanostructures may be incorporated in a filtration membrane formed by the layer-by-layer technique or other types of filtration membranes having an active selective layer. Without wishing to be bound by any particular theory, it is believed that the self-assembled nanostructures form through electrostatic interaction between positively charged nitrogen atoms present in the polyalkyleneimine molecules and amino acid residues in the transmembrane protein that are negatively charged under the conditions (pH, pKs etc.) used to form the nanostructures and/or the membranes comprising the nanostructures.

Accordingly, the self-assembled nanostructures of the aspects of the disclosed embodiments differ from the vesicles in the prior art in which membranes comprising transmembrane proteins are immobilized in lipid bilayer or bilayer-like structures in which the proteins are incorporated in the bilayers of individual vesicles or cells or else are incorporated in the boundary layer between adjacent cells in a liquid membrane. In both instances, the bilayer has the function of separating an internal phase within the cells from a surrounding external phase in which the cells are suspended. In contrast, in the self-assembled nanostructures of the present invention, the transmembrane protein molecules and the polyalkyleneimine molecules associate or form a complex in a way that substantially does not lead to a boundary layer that leads to distinct internal and external phases, but rather provides a composition of nanostructures that can be deposited or otherwise provided as an active layer and/or selective structure of a separation membrane.

Accordingly, in one aspect, the aspects of the disclosed embodiments provide a method step involving self-assembled nanostructures formed between positively charged polymers such as polyalkyleneimines (PAI), such as polyethyleneimine (PEI), and one or more transmembrane proteins, such as AQPs, and especially transmembrane proteins being detergent solubilized. The transmembrane protein has negatively charged amino acid residues available for complex formation or a charge interaction with the positively charged polymers to form aggregates, for example through electrostatic interactions. More particularly, it has been found that the size of the formed nanostructures is dependent of the molecular structure and the molecular weight of the PAI (or PEI) polymer and the ratio of polymer to protein used.

Therefore, the aspects of the disclosed embodiments provide hollow fiber membranes, such as filtration membranes or TFC membranes, having AQPs incorporated in the active layer to facilitate water transport, where the AQPs are immobilised into self-assembled PAI nanostructures, such as self-assembled PEI nanostructures. The aspects of the disclosed embodiments further provide liquid compositions comprising the PAI-protein nanostructures which can be incorporated in the active layer of various separation membranes (including filtration membranes), such as nanofiltration membranes, forward osmosis membranes and reverse osmosis membranes.

In a further aspect, the aspects of the disclosed embodiments provide single hollow fibers or bundles of hollow fibers modified with a selective layer comprising the self-assembled nanostructures of the present invention. Conveniently, the selective layer comprises a thin film composite (TFC) layer on the outside surface of the fibers.

The presence of the thin film on the outside of a hollow fiber provides for a larger membrane area compared to hollow fibers in which the film is present on the inside, i.e. in the lumen of the hollow fiber. A larger membrane area translates into a larger filtration capacity for a certain volume of a membrane module.

In a related aspect, the aspects of the disclosed embodiments provide a method of preparing a hollow fiber (HF) module comprising a bundle of fibers surrounded by a protective shell, wherein the fibers are modified with a selective layer comprising the self-assembled nanostructures of the present invention, the method comprising contacting the fibers with a liquid composition comprising the self-assembled nanostructures and reacting the liquid composition in an interfacial polymerization reaction to form the selective layer comprising the self-assembled nanostructures. The method can be used to form selective layers on various other membrane forms, such as tubular membranes.

In HF modules, the protective shell typically has an elongate form, with bundle of fibers longitudinally arranged inside the protective shell.

In a further aspect, the aspects of the disclosed embodiments provide the use of an HF module of the aspects of the disclosed embodiments for extraction of pure water through forward osmosis.

In a further aspect, the aspects of the disclosed embodiments provide the use of an HF module of the present invention for re-extraction of pure water from a patient's plasma lost through hemodialysis, hemodiafiltration or hemofiltration, for example in the manner disclosed in WO2015/124716.

In a further aspect, the aspects of the disclosed embodiments provide the use of an HF module of the aspects of the disclosed embodiments for up-concentration of heavy water fractions from a natural water source.

Various aspects of the aspects of the disclosed embodiments employ a hollow fiber (HF) module having hollow fiber membranes modified with a selective layer comprising self-assembled nanostructures formed by self-assembly of polyalkyleneimine (PAI), such as PEI, and a detergent solubilized transmembrane protein. Generally, the PEI is a substantially linear polymer having an average molecular weight of between about 2,000 Da to about 10,000 Da, such as between about 3,000 Da to about 5,000 Da; and the transmembrane protein is an aquaporin water channel; and the detergent is selected from the group consisting of LDAO, OG, DDM or a combination thereof; and where the selective layer comprises a thin film composite (TFC) layer formed on the outside surface of the fibers through an interfacial polymerisation reaction; and where the TFC layer comprises aquaporin water channels that are functionally encapsulated in PAI or PEI nanostructures or the aquaporin water channels are incorporated in amphiphilic vesicles, such as diblock or triblock copolymer vesicles or lipid vesicles; and where said HF modules are coated using the method described herein.

Furthermore, when said transmembrane protein comprises an ion channel or an aquaporin or the like, and said nanostructures comprising said transmembrane protein are immobilized or incorporated in said active or selective layer, it becomes feasible to manufacture separation membranes or filtration membranes having diverse selectivity and transport properties, e.g. ion exchange membranes when said transmembrane protein is an ion channel, or water filtration membranes when said transmembrane protein is an aquaporin. As the transmembrane protein maintains its biologically active folded structure when complexed into the self-assembled nanostructures and is shielded from degradation, even sensitive amphiphilic proteins may become sufficiently stable when processed into separation membranes in lab and industrial scale and hence preserve their functionality.

Moreover, the aspects of the disclosed embodiments relate in a method step to a liquid composition comprising a self-assembled nanostructure, wherein the transmembrane protein is an aquaporin water channel as described above, optionally comprising a buffer, and a method of making the liquid composition in which a solution of polyalkyleneimine is mixed with a detergent solubilized transmembrane protein to form a liquid formulation that is stable, even at room temperature and above. The liquid composition form is particularly useful as an intermediate that may be added into a di- or triamine solution or otherwise applied during the membrane fabrication process, such as during an interfacial polymerization forming a TFC layer. A special feature of the present invention is that the PAI nanostructures may be able to participate in said interfacial polymerization as described below, and, thus, reinforce the thin film and the immobilization of aquaporin water channels therein (Kah et al., pH stable thin film composite polyamine nanofiltration membranes by interfacial polymerisation; Journal of Membrane Science, 478: 75-84, 2015).

The separation membranes of the aspects of the disclosed embodiments are useful in a method of preparing a pure water filtrate, such as filtering an aqueous solution through a separation membrane in a nanofiltration process, in a forward osmosis process, or in a reverse osmosis process.

In addition, the separation membrane of the aspects of the disclosed embodiments are useful in a method for the concentration of a product solution, said method comprising utilizing a separation membrane of the invention mounted in a filter housing or module to extract water from the product solution, e.g. by forward osmosis, thus creating a product solution having higher end concentration of desirable solutes therein.

The separation membranes of the aspects of the disclosed embodiments may additionally be useful in a method for the production of salinity power using pressure retarded osmosis, said method comprising utilizing said separation membrane to increase hydrostatic pressure, and using the increase in hydrostatic pressure as a power source, cf. WO2007/033675 and WO2014128293 (A1).

Embodiments of the present disclosure will now be described by way of example and not limitation with reference to the accompanying examples. However, various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the present disclosure and apply equally to all aspects and embodiments which are described.

### DETAILED DESCRIPTION

More specifically, the aspects of the disclosed embodiments relate to a method of producing a hollow fiber membrane having an outside coating with a thin film composite (TFC) layer comprising a transmembrane protein in a self-assembled nanostructure as disclosed herein, which nanostructure is formed by self-assembly of the positively charged PEI in presence of the protein when being negatively charged.

Examples of transmembrane proteins are integral membrane proteins including aquaporin water channels. i.e. aquaporins and aquaglyceroporins, such as those listed below. At pH 7.5 the protein is negatively charged as proved when reconstituted inside proteoliposomes that will exhibit a negative value of their zeta potential value (Wang S et al., Membranes, 5(3): 369-384, 2015). This is due to the presence of negatively charged amino acid residues (aspartic acid and glutamic acid) with pKa at 3.9 for aspartic acid and 4.2 for glutamic acid (Kong S et al. RSC Adv., 4: 37592-37599, 2014). In addition, these proteins have a cysteine residue situated at the exterior surface when properly folded, said cysteine being negatively charged at pH 7.5 inducing also a negative value of the zeta potential as has been shown for 1,2-diphytanoyl-sn-glycero-3-phosphocholine (DPhPC) proteoliposomes containing AqpZ (Li et al., Fusion behaviour of aquaporin Z incorporated proteoliposomes investigated by quartz crystal microbalance with dissipation (QCM-D); Colloids and Surfaces B-biointerfaces, 111: 446-452, 2013).

The aspects of the disclosed embodiments include a liquid composition in a method step, comprising a self-assembled nanostructure as disclosed herein in which the transmembrane protein is detergent solubilized, for example using a suitable detergent such as LDAO, OG, DDM or the like, optionally in combination with a pH buffer to maintain negatively charged amino acid residues of said transmembrane protein, e.g. for aquaporins buffering above pH 4, using e.g. a phosphate buffer, corresponding to the pKa of negatively charged amino acid residues. Other optional components of the liquid composition are biological buffer, e.g. HEPES sodium salt, cf. 54466 HEPES sodium salt from Fluka, (Industriestrasse 25, CH-9471 Buchs), Tris buffer, TES, MES, and MOPS buffers.

In addition, the aspects of the disclosed embodiments involve a method step of making the liquid composition as disclosed, where, as an example, a solution of a PAI, such as polyethyleneimine (PEI), is mixed with a suspension of negatively charged protein having a negatively charged amino acid residue. In this way structures are formed when the PEI solution complexes the charged protein as has been shown for PEI DNA and PEI RNA complexes (Sun et al., Molecular Dynamics Simulations of DNA/PEI Complexes: Effect of PEI Branching and Protonation State, Biophysical Journal Volume 100 June 2011 2754-2763; Mansoor M Amiji Polymeric Gene Delivery: Principles and Applications. Examples of PEIs are linear and branched polymers as outlined below.

Moreover, the aspects of the disclosed embodiments relates to a hollow fiber membrane having an outside coating with a thin film composite (TFC) layer, such as in the form of a semipermeable or selectively permeable membrane, comprising self-assembled nanostructures as disclosed herein. The separation membrane may be in the form of a hollow fiber membrane comprising a porous substrate or support membrane, e.g. a nanoporous or microporous membrane having a separation layer or an active layer in which the self-assembled nanostructures are immobilized.

The TFC skin layer is typically formed by interfacial polymerization to form a thin film or TFC layer, e.g. a crosslinked aromatic polyamide layer. In an alternative embodiment, the active/selective layer may be formed by depositing nanosized alternating positive and negatively charged polyelectrolyte layers, i.e. a layer-by-layer film (LbL) (see Wang et al., Membranes, 5(3): 369-384, 2015).

The filtration membrane according to the present disclosure may be prepared by adding a liquid composition comprising said self-assembled nanostructures, e.g. with aquaporin water channel proteins as the transmembrane protein needed to form structures, during the membrane fabrication process, such as adding the liquid composition to the di- or triamine solution when forming a TFC layer, or by addition to a liquid positively charged polyelectrolyte when forming an LbL skin.

In another aspect of the method of the disclosed embodiments, the transmembrane protein may be an anion channel protein, such as a voltage-dependent anion channel, which is useful in preparation of ion exchange membranes for reverse electrodialysis, cf. Dlugolecki et al. (Journal of Membrane Science, 319 214-222, 2008).

### Definitions and Terms

The term “transmembrane protein” (TP) as used herein is a type of membrane protein spanning the entirety of the biological membrane to which it is permanently attached in nature. That is, in nature, transmembrane proteins span from one side of a membrane through to the other side of the membrane. Examples of transmembrane proteins are ammonia transporters, urea transporters, chloride channels, and aquaporin water channels.

The term “aquaporin water channel” as used herein includes a functional natural or synthetic aquaporin or aquaglyceroporin water channel, such as aquaporin Z (AqpZ), GIPf, SoPIP2;1, aquaporin 1 and/or aquaporin 2. Aquaporin water channels include bacterial aquaporins and eukaryotic aquaporins, such as yeast aquaporins, plant aquaporins and mammalian aquaporins, such as aquaporins 9 and 12 as well as related channel proteins, such as aquaglyceroporins. Examples of aquaporins and aquaglyceroporins include: prokaryotic aquaporins such as AqpZ; mammalian aquaporins, such as Aqp1 and Aqp2; plant aquaporins, such as plasma intrinsic proteins (PIP), tonoplast intrinsic proteins (TIP), nodulin intrinsic proteins (NIP) and small intrinsic proteins (SIP), e.g. SoPIP2;1, PttPIP2;5 and PtPIP2;2; yeast aquaporins, such as AQY1 and AQY2; and aquaglyceroporins, such as GlpF and Yfl054. Aquaporin water channel proteins may be prepared according to the methods described herein or as set out in Karlsson et al. (FEBS Letters 537: 68-72, 2003) or as described in Jensen et al. US 2012/0080377 A1 (e.g. see Example 6).

The term “separation membrane” as used herein includes membranes of tubular or hollow fiber structures useful for separating water and, optionally, certain small size solutes including anions and cations, from other solutes, particles, colloids and macromolecules. Examples of separation membranes are “filtration membranes” such as nanofiltration (NF) membranes, forward osmosis (FO) membranes and reverse osmosis (RO) membranes. One type of filtration membranes is a “thin film composite” (or TFC) membrane, often classified as nanofiltration and reverse osmosis membrane. TFC hollow fiber membranes are made by forming a polyamide layer through interfacial polymerization on the outside of a polyethersulfone (PES) or polysulfone (PS) porous layer. The polyamide rejection layer is formed through interfacial polymerization of an aqueous solution of an amine with a solution of an acid chloride in an organic solvent. Another type of filtration membranes is those formed by the layer-by-layer (LbL) deposition method, such as described in Gribova et al. (Chem. Mater., 24: 854-869, 2012) and Wang et al. (Membranes, 5(3): 369-384, 2015).

HF modules are known in the art and generally are based on polyethersulfone (PES) fibers or fibers of other suitable porous support material, such as polysulfone (PS), polyphenylene sulfone, polyether imide, polyvinylpyrrolidone and polyacrylonitrile including blends and mixtures thereof. In addition, various doping materials may be used when manufacturing the hollow fiber support materials. The present invention uses the known HF modules or the single fibers included in the HF modules as a supporting structure for the TFC layer. Such known HF modules are commonly used in food and beverage applications such as filtering beer and wine, in some water and wastewater applications including wastewater reuse and pool water recycling and for hemodialysis. For instance, the German company Membrana supplies a hollow fiber module containing several thousands of fibers with an overall surface area of 75 square meters per module. Smaller modules with typically 1-2 square meters and around 8,000 to 20,000 fibers are commonly used in medical dialysis applications (Fresenius Medical Care, Gambro). HF modules for use in the method of the invention are typically microfiltration modules or nanofiltration modules having a molecular weight cut-off range of from 20 to 50 kDa. or such as from 30 to 40 kDa. In principle, all these commercial products can be coated through interfacial polymerization with the self assembled nanostructures or compositions of the present invention, for example resulting in a thin film composite layer wherein aquaporin water channels are incorporated. The housing material of the HF modules of the invention can be any suitable material commonly used for HF modules, such as polycarbonate, polysulfone, POM (all of which are transparent), or polypropylene, polyethylene, PVDF and stainless steel can be used. The fibers may be sealed into the HF module housing using commonly known polyurethanes or epoxy adhesive materials and the like. Tubular modules may also be coated in the same way, such as modules described in http://synderfiltration.com/learning-center/articles/module-configurations-process/tubular-membranes/

Additional examples of HF modules that may be TFC modified according to the invention are found on websites of membrane producers, such as:
http://www.membranafiltration.com/filtration-modules/documentation.cfm
http://www.kochmembrane.com/PDFs/KMS_Puron_Hollow_Fiber_PSH300_PSH600_PSH1800_Modul.aspx
http://www.kochmembrane.com/Membrane-Products/Hollow-Fiber/Ultrafiltration/PURON-Series.aspx
http://www.daicen.co.jp/english/membrane/kogata.html
http://www.spectrumlabs.com/filtration/hfmods.html
http://www.microdyn-nadircom/en/Products/

“Thin-film-composite” or “TFC” membranes as used herein may be prepared using an amine reactant, preferably an aromatic amine, such as a diamine or triamine, e.g., 1,3-diaminobenzene (m-Phenylenediamine—abbreviated MPD, generally having a purity of >99%, e.g. as purchased from Sigma-Aldrich) in an aqueous solution, and an acyl halide reactant also known herein as an amine-reactive molecule, such as a di- or triacid chloride, preferably an aromatic acyl halide, e.g. benzene-1,3,5-tricarbonyl chloride (CAS No. 84270-84-8, trimesoyl chloride (TMC), having a purity of around 98%, e.g. as purchased from Sigma-Aldrich) dissolved in an organic solvent where said reactants combine in an interfacial polymerization reaction, cf. U.S. Pat. No. 4,277,344 which describes in detail the formation of a composite membrane comprising a polyamide laminated to a porous membrane support, at the surface of the support membrane, e.g. a polyethersulfone membrane. In general the concentration of the di- or triamine in the aqueous solution is about 1% to about 5% (w/w). Benzene-1,3,5-tricarbonyl chloride is dissolved in a solvent, such as a C₆-C₁₂ hydrocarbon including hexane (>99.9%, Fisher Chemicals), heptane, octane, nonane, decane etc. (straight chain or branched hydrocarbons) or other low aromatic hydrocarbon solvent, e.g. Isopar™ G Fluid which is produced from petroleum-based raw materials treated with hydrogen in the presence of a catalyst to produce a low odour fluid the major components of which include isoalkanes. Isopar™ G Fluid: Chemical Name: Hydrocarbons, C10-C12, isoalkanes, <2% aromatics; CAS No: 64742-48-9, chemical name: Naphtha (petroleum), hydrotreated heavy (from ExxonMobil Chemical). Generally, the concentration of the di- or triacyl halide in the apolar solution is 0.05% to about 1% (w/v). Alternatives to the reactant 1,3-diaminobenzene include diamines such as hexamethylenediamine etc., and alternatives to the reactant benzene-1,3,5-tricarbonyl chloride include a diacyl chloride, adipoyl chloride etc. as known in the art. Interestingly, the amine-reactive molecule, such as TMC, may form condensation products or polymers with amine groups in the PAI polymers in an interfacial polymerization reaction, e.g. as described by X. Feng et al. (Journal of Membrane Science, 472: 141-153, 2014) who have shown how successive layers of aromatic polyamide are formed on a PES support in an interfacial polymerization reaction between PEI and TMC to create a nanofiltration membrane.

The term “polyalkylimine” (PAI) includes any oligomer or polymer, or mixture thereof, which is made by polymerization of an alkylimine monomer having at least one “imine” group (—N(H)—) incorporated therein. In one embodiment, the polyalkylimine is an amine containing polymer comprising alkyl- or alkenyl-derived units (such as C₂-C₈ alkyl- or alkenyl-derived units) in the backbone. Preferably, the PAI comprises imine-derived units (amine groups) and alkyl-derived units, and most preferably, the PAI consists of amine groups and alkyl-derived units. Preferably, the PAI is selected from the group consisting of poly(ethyleneimine), poly(propyleneimine), poly(propyl-co-ethyleneimine), poly(allylamine), and mixtures thereof. In any case, the PAI preferably has a weight average molecular weight (M_{w}) of about 500 or about 1,000 or higher, such as about 2,000 or 3,000 or 5,000 or 10,000 or 20,000 or 40,000 Da.

The condensation polymers described herein are typically produced in an aqueous solution by combining the amine-reactive molecules with a PAI. Amine-reactive molecules are molecules that include at least one moiety that will react with an amine/imine to form a covalent or ionic chemical bond, preferably covalent. Desirably, there are from 0.1 or 0.2 to 0.6 or 0.8 or 1.0 or 1.1 or 1.2 or 2.0 or 2.5 or 3.0 amine-reactive equivalents (“ARE”) of the amine-reactive molecules that are combined with the PAI. Desirably, the product can be isolated from an aqueous diluent in solution or substantially in solution at a pH of at least 8. The product of the condensation reaction between the PAI and amine-reactive molecule is the condensation polymer as described herein, but in certain embodiments it is not necessary to specifically isolate the condensation polymer from the reaction medium, hence, in certain embodiments, the usefulness of the condensation polymer is as the entire mixture or condensation product.

The term “polyethyleneimine” (PEI) as used herein includes a polymer with repeating units composed of —NHCH₂CH₂— (an amine group and two methylene groups):

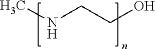

Linear polyethyleneimines contain secondary amines, whereas branched polyethyleneimines may contain primary, secondary and tertiary amino groups. Various linear PEI with molecular weight ranging from 1,000 Da or 1,500 Da or 2,000 Da 2500 Da to 4,000 Da or 5000 Da or 8,000 Da or 10,000 Da may be used as well as branched PEI with molecular weights ranging from 800 Da to 2,000 Da. In general, an increase in the branching and molecular weight of the PEI, with lead to an increase in the possible loading of the protein in the structures formed between the PEI and the protein, typically accompanied by size increase of the formed structures. Having in mind that for some applications, such as the production of filtration membranes, the final size of the formed structures should preferably not exceed a maximum of 200 nm the entire library of available PEIs with various molecular weights, linear and branched can be considered. For the PEI-protein complexes a narrow size distribution of around 200 nm (250 to 150 nm) is presently considered the most promising for incorporation into the active layer of filtration.

All functional polymers have positive charges concentration dependent in accordance with the literature and observations. The more negative the self-assembled structures the larger the structures as measured by DLS. LDAO is very dilute and has negative charge as measured by zeta potential. A colloidal system where structures are sustained in suspension.

The abbreviation Mₙ means number average molecular weight. It means the total weight of polymer divided by the number of polymer molecules. Thus, Mₙ is the molecular weight weighted according to number fractions. The abbreviation M_{w} means weight average molecular weight. The molecular weight weighted according to weight fractions. Molecular mass may be measured by gel permeation chromatography (GPC) in tetrahydrofuran. Polydispersity index defined as Mₙ/M_{w} will be determined from the elution curves obtained in GPC.

Size of the nanostructures: Preferably, the nanostructures of the present invention have a particle size of between about 10 nm diameter up to 200 nm to about 250 nm diameter depending on the precise components of the nanostructures and the conditions used for their formation. It will be clear to those skilled in the art that a particle size refers to a range of sizes and the number quoted herein refers to the average diameter, most commonly mean hydrodynamic diameter of that range of particles. The nanostructure compositions of the present invention comprise nanoparticles having mean diameters of from about 250 nm to about 200 nm or less, in some cases mean diameters that are less than 200 nm such as less than about 180 nm or less than about 150 nm.

Examples of molar ratios of transmembrane protein to PAI (such as PEI) is dependent on the transmembrane protein used, the type of PAI used, the degree or amount of branched PAI as opposed to linear PAI, and the desired size of the nanostructure. As an example, for nanostructures of PEI and aquaporin water channels, the molar ratio of transmembrane protein to PEI may be between 1:200 to 1:2000, such as 1:400 to 1:1500, such as 1:600 to 1:1000.

Examples of linear polyethyleneimines that may be used in accordance with the present invention include: Polyethylenimine, linear, 764582 ALDRICH, (average Mn 5,000, PDI<1.2); Polyethylenimine, linear, 764604 ALDRICH, (average Mn 2,500, PDI<1.2); and Polyethylenimine, linear, 765090 ALDRICH, (average Mn 10,000, PDI 1.2). Examples of branched polyethyleneimine are: Polyethylenimine, branched, 407819 ALDRICH (average Mw 800 by LS, average Mn 600 by GPC), Polyethylenimine, branched, 408727 ALDRICH (average Mw˜25,000 by LS, average Mn˜10,000 by GPC). Polysciences, Inc is also provider of some linear polyethyleneimines, polyallylamine M_{w}˜17,000, 479136 ALDRICH, CAS Number 30551-89-4, Linear Formula [CH2CH(CH2NH2)]n.

BASF Lupasol®, cf http://product-finder.basf.com/group/corporate/product-finder/de/brand/LUPASOL (accessed on Feb. 8, 2016). Examples of dendritic PEI are: Polyethylene imine dendritic 5000 Da and 25000 Da (Nanopartica) and Polyethylene imine dendritic 5000 Da alkane functionalized (Nanopartica).

The term “self-assembled” as used herein refers to the process by which nanostructures formed from polyalkyleneimine, such as polyethyleneimine, components and transmembrane protein components form organized, ordered structures as a result of the ionic or charged interactions between the components, without external direction. In the present invention, “self-assembled” is synonymous with the term “molecular self-assembly”. The general properties of self-assembled systems are described at https://en.wikipedia.org/wiki/Self-assembly#Interactions [accessed 8 Feb. 2016], In the present invention, the self-assembled nanostructures formed between polyethyleneimine components and (negatively) charged protein components are believed to be driven by the ionic interactions between the cationically charged polyethyleneimine molecules and anionically charged amino acid residues of the protein component.

The term “nanostructures” as used herein refers to particles having a nanomeric scale, and is not intended to convey any specific shape limitation. In particular, “nanostructure” encompasses nanospheres, nanotubes, nanoboxes, nanoclusters, nanorods, and the like. In certain embodiments, the nanostructures may be nanoparticles and/or nanoparticle cores having a generally polyhedral or spherical geometry.

The term “size” as used herein refers to a hydrodynamic diameter of the self-assembled nanostructures.

### EXAMPLES

The aspects of the disclosed embodiments are further illustrated with reference to the following non-limiting examples

### Experimental Section

### Equipment:

ÂKTA Start FPLC connected with Laptop, using Unicorn operating system.
Vacuum stream.
Sterile 0.45 μM vacuum filter cup.
15 mL PP tubes.

### Abbreviations

CV: column volume.
AQP: Aquaporin Z from E. coli.

### LDAO: N,N-Dimethyldodecylamine N-oxide (#40234, Sigma).

PAGE: Polyacrylamide gel electrophoresis.

### Materials and Chemicals:

HisTrap Gel filtration material (Ni Sepharose 6 Fast Flow #17-5318-03, GE Healthcare) packed into a XK16/20 column (GE Healthcare) at known volume or prepacked 1 ml, 5 ml HisTrap column.
AQP Binding buffer: 20 mM sodium phosphate, 300 mM NaCl, 20 mM imidazole, 10% glycerol, 0.2% LDAO, pH8.0.
LDAO-free AQP Binding buffer: 20 mM sodium phosphate, 300 mM NaCl, 20 mM imidazole, 10% glycerol, pH8.0.
Imidazole-free AQP Binding buffer: 20 mM sodium phosphate, 300 mM NaCl, 10% glycerol, 0.2% LDAO pH8.0.
AQP Elution buffer: 20 mM sodium phosphate, 300 mM NaCl, 200 mM imidazole, 10% glycerol, 0.2% LDAO, pH8.0, ddH₂O.

General Purification of Aquaporin and Preparation of Aquaporin Stock Solution

### Recombinant Production of Aquaporin Z

All types and variants of aquaporin water channel proteins, including aquaglyceroporins, may be used in the manufacture of membranes and compositions according to this invention, cf. methods described in WO2010/146365. Representative examples include the spinach aquaporin SoPIP2;1 protein and the bacterial aquaporin-Z from E. coli.

Functional aquaporin-Z was overproduced in E. coli strain BL21(DE3) bacterial cultures as His-tagged protein with a tobacco etch virus cleavage site. The fusion protein has 264 amino acid and a Mw of 27234 Da. Genomic DNA from E. coli DH5 was used as a source for amplifying the AqpZ gene. The AqpZ gene was amplified using gene specific primers with the addition of a tobacco etch virus cleavage site (TEV); ENLYFQSN at the N-terminus of AqpZ. The amplified AqpZ was digested with the enzyme NdeI and BamHI and then ligated to the similarly digested 6-His tagged expression pET28b vector DNA. The positive clones were verified by PCR-screening. The authenticity of the constructs was then confirmed by DNA sequencing.

The E. coli strain BL21(DE3) was used for expression of the protein. Luria Broth cultures containing 50 μg/ml kanamycin were incubated for 13-16 hours at 37 C, diluted 100-fold into fresh LB broth and propagated to a density of about 1.2-1.5 (OD at 600 nm). Expression of recombinant protein was induced by addition of 1 mM IPTG for 3 hour at 35° C. before centrifugation. Harvested cells were resuspended in ice-cold binding buffer (20 mM Tris pH 8.0, 50 mM NaCl, 2 mM β-mercaptoethanol, 10% glycerol) in the presence of 0.4 mg/ml lysozyme, 50 units Bensonase and 3% n-octyl β-D-Glucopyranoside. The sample was subjected to five times lysis cycles in a microfluidizer at 12,000 Pa. Insoluble material was pelleted by 30 minutes centrifugation at 40,000×g. The supernatant was passed through a Q-Sepharose fast flow column (Amersham Pharmacia), and the flow through was 10 collected. The flow though fraction was topped up with NaCl to 300 mM before loaded onto a pre-equilibrated Ni-NTA column. The column was washed with 100 column volumes of a wash buffer (20 mM Tris pH 8.0, 300 mM NaCl, 25 mM imidazole, 2 mM β-mercaptoethanol, 10% glycerol) to remove non-specifically bound material. Ni-NTA agarose bound material was eluted with five bed volumes of elution buffer (20 mM Tris pH 8.0, 300 mM NaCl, 300 mM imidazole, 2 mM β-mercaptoethanol, 10% 15 glycerol, containing 30 mM n-octyl β-D-Glucopyranoside). AqpZ was further purified with anion exchange chromatography; monoQ column (GE healthcare). The sample mixture was diluted and concentrated to bring the salt and imidazole concentration to approximately 10 mM with Amicon concentrator, membrane cut off 10,000 Da before loading to MonoQ column. The buffer used during anion exchange chromatography were (A) 20 mM Tris pH 8.0, 30 mM OG, 10% glycerol and (B) 20 mM 20 Tris pH 8.0, 1 M NaCl, 30 mM OG, 10% glycerol. The eluted peak fractions containing AqpZ from the ion exchange column was pooled. The purified AqpZ extract was kept frozen at −80° C.

### Procedure for Purification of Aquaporin Protein

A batch of frozen extract of aquaporin protein, such as aquaporin Z, AQPZ, e.g. from an E. coli fermentation, was obtained and treated as follows for use in the experiments to produce and characterize membranes comprising protein-PAI nanostructures of the present invention.

One day before the purification experiment, the AQP extract (stored at −80° C. freezer) was thawed on ice or in a 4° C. refrigerator. Portions of the buffers and ddH₂O were readied at 4° C. The AQP extract was stirred in an adequate chilled beaker on ice bath by a magnetic stick to dissolve any precipitate. 1.5 volumes of pre-chilled LDAO-free AQP binding buffer was gradually added into 1 volume of the solubilized extract (using a further 0.5 volume buffer for rinsing the extract tubes and filtration cup), mixed well and filtered through a sterile 0.45 μM vacuum filter cup. Vacuum was applied to the filter cup to avoid excess foaming and the filtrate was placed on ice to use within 2 hours.

A Histrap column was equilibrated with sterile water followed by AQP Binding buffer at RT. The flow rate was set at 1 ml/min (for 1 mL prepacked column) or 2.5 ml/min (for 5 ml prepacked column and self-packed column). The 3 times diluted extract (on ice water bath) was loaded onto the Histrap column using ÄKTA program. The flow rate was set at 1 ml/min (for 1 mL prepacked column) or 2.5 ml/min (for 5 mL prepacked column and self-packed column). The loading volume was less than 30 ml/ml resin. The extract flow-through on ice-water bath was collected and stored at 4° C. for further use. The column was washed with 10 CV (column volume) ice cold AQP binding buffer. The flow rate was set at 2.5 ml/min (for 5 ml prepacked column and self-packed column) or set at 1 ml/min for 1 ml prepacked column. The AQP protein was eluted with ice cold AQP elution buffer (10 column volume) at flow rate 2.5 ml/min using ÄKTA program. The fraction volume was set to 10 ml and collection started in 15 mL PP tubes after 0.5-1 CV.

Eluted fractions were capped and stored on ice or 4° C. The AQP purity and conformation was examined by denaturing and native PAGE analysis respectively. Protein concentration was measured by Nanodrop. The extract flow-through may be processed a second and a third time as needed to produce an AQP composition of suitable quality.

When AQP quality analyses are passed, the protein concentration may be adjusted to 5 mg/ml by adding ice cold imidazole-free AQP binding buffer containing 2% LDAO. Finally the AQP was sterilized by filtration through 0.45 μM sterilized cup and stored at 4° C. in refrigerator for use within a month or else stored at −80° C. in a freezer.

### Example 1. Preparation and Stopped Flow Testing of PEI-Aquaporin-Z Nanoparticles

Poly(ethyleneimine) with MW of 4000 Da (linear) (PEI) was purchased from Sigma Aldrich and was used as received without any other purification. 10 mM phosphate saline solution (PBS) (pH 7.2, 136 mM NaCl, 2.6 mM KCl) was prepared by dissolving 8 g NaCl, 0.2 g KCl, 1.44 g Na₂HPO₄ and 0.24 g of KH₂PO₄ in 800 mL MilliQ purified H₂O, adjusting the pH to 7.2 with HCl and completing the volume to 1 L. N,N-Dimethyldodecylamine N-oxide BioXtra (Lauryldimethylamine N-oxide) (99% purity), LDAO was purchased from Sigma Aldrich.

PEI based self-assembled structures were prepared by direct dissolution method. For that first 100 ml 5 mg/mL PEI in phosphate saline buffer with pH of 7.2 solution was prepared by dissolving 500 mg PEI powder in 100 mL PBS with pH 7.2. Further, 100 mL 5 mg/mL PEI were directly mixed with 1.5 mg as 0.3 mL from 5 mg/mL Aquaporin Z (AQPZ) purified stock solution in 2% LDAO, corresponding to a 1/800 AQPZ/PEI molar ratio of the two components mixture. The PEI-AQPZ mixture was stirred overnight at 170 rotations per minute, overnight not more than 20 hours (but not less than 12 h).

After stirring, next day the mixture was transferred in 100 mL glass bottle and kept at room temperature. The mixture (the liquid formulation—or composition—of PEI-AQPZ based self-assembled structures) can be kept for more than two months. After transfer to the storage glass bottle, the size and the permeability of the PEI-AQPZ self-assembled structures were determined by dynamic light scattering using a ZetaSizer NanoZs from Malvern and stopped-flow using a Bio-Logic SFM 300.

The size of PEI-AQPZ based self-assembled structures was determined as 114±20 nm (80%) of the population, while 20% had a size of around 147±15 nm. In plus the zeta potential was determined for the PEI-AQPZ self-assembled structures as 18.4 mV, indicating the positive charge of the structures.

The permeability data obtained from stopped-flow measurements in 0.3 M NaCl as the osmolyte lead to a fast diffusion coefficient Kᵢ of 1605 s⁻¹, corresponding to an osmotic permeability Pf of 22 μm/sec and a permeability of 11 LMH/bar (L/m²/h)/bar).

The temperature stability of the PEI based self-assembled structures was determined by warming up 5 mL for 10 min at various temperatures ranging from 30 to 100° C. and their size and water permeability was further determined by dynamic light scattering and stopped-flow measurements.

The size of the self-assembled structures after the thermal treatment are presented in Table 1.

TABLE 1
Size distribution of nanoparticles in aqueous composition with PEI
self-assembled polymer structures after thermal treatment.

| | | Population | | |
|---|---|---|---|---|
| Temperature/ | Population 1 | 1 Size/ | Population 2 | Population 2 |
| ° C. | distribution/% | nm | distribution/% | Size/nm |
| RT | 80 | 111 ± 18 | 20 | 147 ± 25 |
| 30 | 81 | 117 ± 20 | 19 | 178 ± 28 |
| 40 | 69 | 118 ± 15 | 31 | 164 ± 14 |
| 50 | 93 | 112 ± 22 | 7 | 156 ± 23 |
| 60 | 85 | 108 ± 23 | 15 | 148 ± 32 |
| 70 | 94 | 92 ± 15 | 6 | 132 ± 24 |
| 80 | 81 | 108 ± 12 | 19 | 137 ± 18 |
| 90 | 84 | 110 ± 14 | 16 | 136 ± 22 |
| 100 | 76 | 115 ± 23 | 24 | 142 ± 16 |

As seen from Table 1, the size of the formed structures is not affected by temperature exposure even though a slight decrease with around 10 nm is observed from 60° C. degrees up. This decrease does not affect the functionality of the nanostructures nor the aquaporin water channels complexed in them when incorporated in the active layer of filtration membranes.

The permeability in the formed nanoparticles after thermal treatment in the presence of AQPZ was determined from the stopped-flow measurements.

TABLE 2
Stopped flow results of composition PEI-AQPZ in 0.3M NaCl.

| Temperature/° C. | Ki Value/s⁻¹ | Pf/μm/sec | Water flux lmh/bar |
|---|---|---|---|
| RT | 1589 | 21.7 | 10.4 |
| 30 | 1601 | 23.1 | 11.1 |
| 40 | 1679 | 24.4 | 11.7 |
| 50 | 1611 | 22.2 | 10.7 |
| 60 | 1707 | 22.7 | 10.9 |
| 70 | 1713 | 20.1 | 9.9 |
| 80 | 1589 | 21.2 | 10.1 |
| 90 | 1540 | 20.9 | 10.03 |
| 100 | 1533 | 21.7 | 10.4 |

From a water permeability point of view in this particular experiment, no significant changes can be observed up to 100° C., a slight fluctuation of both permeability and water flux is correlated with the size change.

### Example 2. Preparation and Testing of PEI Nanostructures with AQP9 and AQP12

In a similar manner, PEI based self-assembled structures with human aquaporins, more specifically aquaporin-9 and aquaporin-12, were prepared by direct dissolution method. For that first 100 ml 5 mg/mL PEI in phosphate saline buffer with pH of 7.2 solution was prepared by dissolving 500 mg PEI powder in 100 mL PBS with pH 7.2. Further, 100 mL 5 mg/mL PEI were directly mixed with 1.5 mg as 0.15 mL from 10 mg/mL Aquaporin-9 and 0.17 mL from 9 mg/mL Aquaporin-12 purified stock solution in 2% LDAO, corresponding to a 1/800 AQP/PEI molar ratio of the two components mixture. The PEI AQP mixture was stirred overnight at 170 rotations per minute, overnight not more than 20 hours (but not less than 12 h).

After stirring next day the mixture was transferred in 100 mL glass bottle, kept at room temperature and measured in the following day. The size and the permeability of the PEI-AQPZ self-assembled structures were determined by dynamic light scattering using a ZetaSizer NanoZs from Malvern and stopped-flow using a Bio-Logic SFM 300.

The size of PEI-AQP9 based self-assembled structures was determined as 91±15 nm (85%) of the population, while 15% had a size of around 325±32 nm. In plus the zeta potential was determined for the PEI-AQP self-assembled structures as 17.9 mV, indicating the positive charge of the structures.

The permeability data obtained from stopped-flow measurements in 0.3 M NaCl as the osmolyte lead to a fast diffusion coefficient Kᵢ of 1326 s⁻¹.

The size of PEI-AQP12 based self-assembled structures was determined as 244±36 nm (92%) of the population, while 8% had a size of around 3±2 nm. In plus the zeta potential was determined for the PEI-AQP self-assembled structures as 17.3 mV, indicating the positive charge of the structures.

The permeability data obtained from stopped-flow measurements in 0.3 M NaCl as the osmolyte lead to a fast diffusion coefficient Kᵢ of 1432 s⁻¹.

### Example 3. Preparation and Testing of Nanostructures with PEI 800 b and 1000 b

In a similar manner as for PEI 4000 Da self-assembled structures with AQPZ, and PEI 800 branched and 10000 branched, were prepared by direct dissolution method. For that first 100 ml 5 mg/mL PEI 800 branched or 10000 branched, in phosphate saline buffer with pH of 7.2 solution was prepared by dissolving 500 mg PEI 800 branched or 10000 branched powder in 100 mL PBS with pH 7.2. Further, 100 mL 5 mg/mL PEI were directly mixed with 1.5 mg as 0.3 mL from 5 mg/mL AqpZ purified stock solution in 2% LDAO, corresponding to a 1/800 AQP/PEI molar ratio of the two components mixture. The PEI AQP mixtures were stirred overnight at 170 rotations per minute, overnight not more than 20 hours (but not less than 12 h). After stirring next day the mixture was transferred in 100 mL glass bottle, kept at room temperature and measured in the following day. The size and the permeability of the PEI-AQPZ self-assembled structures were determined by dynamic light scattering using a ZetaSizer NanoZs from Malvern and stopped-flow using a Bio-Logic SFM 300.

The size of PEI 800 b—AQPZ based self-assembled structures was determined as 180±23 nm (100%) of the population. In plus the zeta potential was determined for the PEI-AQP self-assembled structures as 14 mV, indicating the positive charge of the structures.

The permeability data obtained from stopped-flow measurements in 0.3 M NaCl as the osmolyte lead to a fast diffusion coefficient Kᵢ of 747 s⁻¹.

The size of PEI 10000 b—AQPZ based self-assembled structures was determined as 220±37 nm (100%) of the population. In plus the zeta potential was determined for the PEI-AQP self-assembled structures as 4 mV, indicating the positive charge of the structures.

The permeability data obtained from stopped-flow measurements in 0.3 M NaCl as the osmolyte lead to a fast diffusion coefficient Kᵢ of 1516 s⁻¹.

The temperature stability of the PEI based self-assembled structures was determined by warming up 5 mL for 10 min at various temperatures ranging from 30 to 100° C. and their size and water permeability was further determined by dynamic light scattering and stopped-flow measurements. For the PEI 600 b based AQPZ self-assembled nanostructures the size does not change up to 50° C., and is increasing with more than 200 nm from 50° C. up, while the Ki values varies with less than 100 s⁻¹. For the PEI 10000 b based AQPZ self-assembled nanostructures the size does not change up to 40° C., and is increasing with more than 150 nm from 40° C. up, while the Ki values varies with less than 100 s⁻¹.

### Example 4. Fluorescence Correlation Spectroscopy

The fluorescent labelling of the transmembrane protein AQPZ was performed by N-hydroxysuccinimide ester (NHS-ester) coupling reaction to primary amines on the proteins. The N terminus of the AQPZ protein contains only hydrophilic amino acid residues. Therefore, it is available for the labelling reaction in the aqueous phase and it is not buried in the hydrophobic part of the membrane protein. In this case, the fluorescent dye Oregon Green 488 (OG488) was used.

For labeling (cf. Itel et al., Nano. Lett., 15 (6): 3871-3878, 2015), 1 mg AQPZ stock solution was mixed with Oregon Green 488 succinimidyl ester (OG488, 10 mg/ml in DMSO) at a 10-fold molar excess and incubated on ice with agitation for 3 hours in the dark. After the non-reacted dye was removed by centrifugation through 2000 Da filters the labelled AQPZ was further used for reconstitution in linear PEI 4000 Da self-assembled nanostructures. From the molecular brightness the number of AQPZ tetramers per PEI nanostructure was determined as 8±1. No free protein was detected. For PEI 600 b and 10000 b the number of AQPZ tetramers per PEI nanostructure was determined as 4±1 (PEI 600 b) and 5±2 (PEI 1000 b)

### Example 5. Characterization by Circular Dichroism

The protein conformation of the formed self-assembled nanostructures may be characterized by circular dichroism (CD). CD is a suitable method for rapid determination of the secondary structure (α-helix and the β sheet) and folding properties of proteins that determine its functionality. CD is a spectroscopic technique where the CD spectra of molecules is measured over a range of wavelengths (Greenfield N.J., Nat Protoc. 2006; 1(6): 2876-2890). For that the liquid formulation of PEI-AQPZ based self-assembled structures as prepared according to Example 1 was placed in the measuring cuvette and the CD spectra was recorded and analysed in order to assess the secondary structure of incorporated AQPZ, respectively its functionality.

The secondary structure of AQPZ reconstituted into PEI self-assembled nanostructures showed a negative ellipicity band at 222 nm compared to 208 nm (222/208 nm ratio equal to 1.15), similar as reported for spinach aquaporin reconstituted in E. coli total lipids, indicating that the protein in not unfolded. (Hansen et al., Biochimica et Biophysica Acta 1808: 2600-2607, 2011).

### Example 6. Pilot Machine for Preparing FO Filtration Hollow Fiber Membranes

A TFC layer was formed on a PES hollow fiber membrane using a pilot coating machine.

a) An MPD/water solution was made by dissolving MPD in MilliQ water to get a 2.5% (W/W) concentration.
b) An Aquaporin/MPD/water solution was made by dissolving 6.25 g MPD, 10 mL Composition as prepared in example 1 in 240 mL Di water.
c) TMC was dissolved in Isopar to a final concentration of 0.15% W/V;
d) A roll of hollow fiber support membrane (UltraPES fibers from Membrana GmbH) was installed on the unwinding unit of the machine,
e) The membrane was threaded through the coating rolls
f) The washing bath was filled with Di water
g) The coating process was run (at 0.6 m/min):
membrane was unrolled from unwinder;
then soaked in MPD/water solution in foulard bath;
surface water was removed by air knife (0.5 bar air);
Aquaporin/MPD/water solution was applied via slot die at pump rate of 1.2 mL/min;
surface water was removed via air knife to ensure a droplet free surface before interfacial polymerization (0.75 bar);
TMC/Isopar solution was applied via slot die at 4.2 mL/min to start interfacial polymerization;
Isopar dried off the surface of the membrane at ambient air;
leftover chemicals were removed in wash bath;
coated membrane was rolled up.
   h) The coated membrane was run through a final drying step.

The coated hollow fiber membranes were bundled and surrounded with a cylindrical casing and polymer plugs in each end to form a hollow fiber module. The module was tested for forward osmosis performance. It was possible to obtain a forward osmosis effect, which showed that there was a coating on the membrane.

### Example 7. Preparation of a Hollow Fiber Module Wherein the Outside Surface of the Fibres has been Functionalised with Immobilised AqpZ

A hollow fiber module having polyethersulfone membranes, such as a custom-made module having 9 fibers corresponding to about 10 cm² is used. Alternatively, a membrane area of up to 0.5 m² which may correspond to several hundred fibers depending on module length can be used. A thin film composite layer is prepared on the outside fiber surface through interfacial polymerization involving the following steps:

1) Obtain 4 mL PEI-AQPZ mixture as prepared in example 1 above.
2) Dissolve 1,3-diaminobenzene (m-phenylene diamine—MPD) in MilliQ water to obtain a solution of 2.5% (w/w) concentration.
3) benzene-1,3,5-tricarbonyl chloride (Trimesoyl Chloride—TMC) is dissolved in hexane to obtain a final concentration of 0.15% (w/v).
4) A 1,3-diaminobenzene/AqpZ mixture is prepared by dissolving/mixing 4 mL of the PEI-AQPZ mixture from step 1 with 6 mL of the solution from step 2.
5) fill solution from step 4) into the module on the outside of the fibers using side inlets of the module; flowrate: 5 mL/min.
6) stop flow after 1 min and leave fibers soaking for 1 min.
7) empty the module and purge with air to get leftover MPD solution out.
8) use air flow to remove surface water from the fibers (air flow rate 25 L/min).
9) pump solution from step 3) into the module using a flow rate of 15 mL/min.
10) after module is filled continue pumping for 30 s.
11) disconnect module from syringe and turn upside down to get last solution out; connect to air and purge at 10 L/min for 5-10 s.
12) fill module with MiliQ by sucking it in from a glass.

Forward osmosis performance of the formed HF TFC membrane were determined by the characteristics of the polyamide layer formed in the interfacial polymerization process. A standard membrane test is carried out with 1 M NaCl as a draw solution, and before use conductivity of such prepared solution should be about 92.5±1.5 mS/cm. RO water having a standardized conductivity of <10 μS/cm is used as a feed solution without further processing.

Feed solution was introduced into the module with 4 cm/s on the outside of the fibers through the inlet, whereas draw solution was introduced in the inside of the fibers with 1 cm/s. Draw and the feed were connected in counter-current flow. The pressure of the feed solution and the draw solution from all the inlets were monitored. Tests were carried out at average TMP of 0.2 bar from the feed side. Tests were conducted for 1 hour. The feed solution (here: RO water) and draw solution (1 M NaCl) were not recirculated. Instead, concentrate of feed solution was collected on the balance.

It was possible to obtain a forward osmosis effect, which showed that there was a coating on the membrane. The water flux, Jw, was measured in 5 experiments to be between 2.11 and 3.40 L/m² h. The reverse salt flux, Js, was measured to be in the range of 114 to 254 g/m² h.

1. A method of producing a hollow fiber membrane having an outside coating with a thin film composite (TFC) layer comprising a transmembrane protein, said method comprising the steps of:
a) preparing an aqueous solution comprising
a self-assembled nanostructure comprising polyalkyleneimine (PAI) and a detergent solubilized transmembrane protein and
a di- or triamine,
b) preparing an apolar solution comprising a di- or triacyl halide in an apolar organic solvent,
c) contacting a hollow fiber membrane with either the aqueous solution or the apolar solution,
d) allowing the hollow fiber membrane to absorb the solution and, optionally, removing excess solution,
e) contacting the hollow fiber membrane with the other solution not used in step c),
f) allowing an interfacial polymerization reaction to take place, and
g) rinsing the hollow fiber membrane with an aqueous solvent.

2. The method according to claim 1, wherein the PAI is polyethyleneimine (PEI).

3. The method according to claim 2, wherein the PEI is a substantially linear polymer having an average molecular weight of between about 2,000 Da to about 10,000 Da, such as between about 3,000 Da to about 5,000 Da.

4. The method according to claim 1, wherein the transmembrane protein is an aquaporin water channel.

5. The method according to claim 4, wherein the aquaporin water channels are AqpZ channels or SoPIP2;1 water channels.

6. The method according to claim 1, wherein the detergent is selected from the group consisting of N,N-dimethyldodecylamine N-oxide (LDAO), octyl-glucoside (OG), n-dodecyl β-D-maltoside (DDM), or a combination thereof.

7. The method according to claim 1, wherein the aqueous solution of step a) further comprises a buffer.

8. The method according to claim 1, wherein the self-assembled nanostructure of step a) is prepared by mixing a solution of polyalkyleneimine with a detergent solubilized transmembrane protein.

9. The method according to claim 1, wherein the di- or triamine is m-phenylenediamine (MPD).

10. The method according to claim 1, wherein the hollow fiber membrane material is polyethersulfone (PES) or polysulfone (PS).

11. The method according to claim 1, wherein the concentration of the di- or triamine in the aqueous solution is about 1% to about 5% (w/w).

12. The method according to claim 1, wherein the di- or triacyl halide is benzene-1,3,5-tricarbonyl chloride (TMC).

13. The method according to claim 1, wherein the concentration of the di- or triacyl halide in the apolar solution is 0.05% to about 1% (w/v).

14. The method according to claim 1, wherein the apolar organic solvent is hexane, heptane, octane, or a mixture thereof.

15. The method according to claim 1, wherein the hollow fiber membrane is an endless single hollow fiber.

16. (canceled)

17. The method according to claim 1, wherein the hollow fiber membrane is a bundle of hollow fibers, the bundle of hollow fibers being arranged in a protective shell having an inlet and an outlet for liquid present outside the fibers and an inlet and an outlet for liquids present in the lumen of the hollow fibers, thereby forming a hollow fiber (HF) module.

18. The method according to claim 17, wherein the protective shell has an elongate form and the bundle of fibers is longitudinally arranged inside the protective shell.

19. A hollow fiber membrane obtainable by the method according to claim 1.

20. (canceled)

21. A method for the concentration of a product solution by osmosis, said method comprising utilizing a hollow fiber membrane according claim 19 to extract water from a product solution.

22. A method for the production of salinity power using pressure retarded osmosis, said method comprising utilizing a hollow fiber membrane according to claim 19 to increase hydrostatic pressure, and using the increase in hydrostatic pressure as a source of salinity power.
